(19) United States
(12) Patent Application Publication
(10) Pub. No.: US 2016/0335696 A1
(43) Pub. Date: Nov. 17, 2016

(54) PROCESS FOR LOCATIONALLY SORTING AND CATEGORIZING MOBILE APPLICATIONS AT A GEOGRAPHICAL LEVEL, UTILIZING GPS

(71) Applicants: James Preston Hopkins, San Francisco, CA (US); Colin Bielman, Riverside, CA (US); Jordan Goldin, Westlake Village, CA (US); Nick Zager, Denver, CO (US); Chris Johnson, Thousand Oaks, CA (US); Ryan Roden, Boulder, CO (US)

(72) Inventors: James Preston Hopkins, San Francisco, CA (US); Colin Bielman, Riverside, CA (US); Jordan Goldin, Westlake Village, CA (US); Nick Zager, Denver, CO (US); Chris Johnson, Thousand Oaks, CA (US); Ryan Roden, Boulder, CO (US)

(21) Appl. No.: 15/156,209

(22) Filed: May 16, 2016

Related U.S. Application Data
(60) Provisional application No. 62/162,399, filed on May 15, 2015.

(51) Int. Cl. G06Q 30/06; G06F 17/30

(52) U.S. Cl. CPC G06Q 30/0627; G06F 17/30598; G06F 17/30867; G06F 17/30554; G06F 17/30061; G06Q 30/0641

(57) ABSTRACT

A process for locationally sorting and filtering mobile applications at a geographical level, utilizing location-specific information is disclosed. The ability to filter categories among location-specific displayed application results in an interface creates much greater additional value to consumers, as they can quickly and easily screen applications pertaining to “Dating,” “Transportation” or other categories near them, where both location and underlying functionality are equally important. Additionally, browsing is encouraged under this system, as users do not have to continually enter new terms and hit search to generate new application search results.

### CROSS-REFERENCE TO RELATED APPLICATIONS

This Application claims the benefit of U.S. Provisional Application No. 62/162,399, filed May 15, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPLICATIONENDIX

Not Applicable

### BACKGROUND OF THE INVENTION

The invention relates generally to mobile applications and in particular to a process for using location data to filter mobile application results. Mobile applications, particularly when used on a tablet or smartphone, have proven to be extremely useful. This is especially true for users who are traveling. Unfortunately, most applications could become more user friendly and are, at best, user indifferent. They acquire and present a large amount of information which could be very useful, but fail to present the information in a way that is convenient for the user. In many cases, search results are not geographically centered on the user's location. In others, results could be categorized in a manner that presents the information in a more useful way, such as separating Chinese, Italian, and pizza restaurants, or restaurants which deliver their food to residences, from other type of restaurants.

Currently, existing application stores allow for the display of applications nearby a user, but do not allow for refining of search by category, unless the user can differentiate by function. A search of the prior art reveals various applications which have been developed from time to time to sort the results of searches, but the usefulness of these applications has been limited. None are closely related to the present invention, but several include features which resemble those of the present invention. Each has proven to be less than satisfactory in its own way.

Optimization method and device with searching, Chinese Patent No. CN103886039A (filed Mar. 10, 2014), provides an optimization method wherein the current features are matched with an obverse arraying table, the attribute of the current features is determined according to the matching results, and according to the attribute, the application related to the current features is subjected to normalization processing according to the attribute. According to the normalization processing results, the application is sorted, so that searching is carried out conveniently according to the sorting results. According to the optimization method with searching, by obtaining the current features and carrying out normalization processing on the related application according to the current features, so that more features are added into the obverse arraying table of the related application, accordingly, the relevancy of the application is optimized so that when a user searches with the application, the user can obtain reasonable searching results, and user experience is improved.

Intelligent media management system, U.S. Patent Appl. Publ. No. 2016/0012078 (filed Jul. 14, 2014), provides an intelligent media management system which can facilitate more organized storage of media, including photos and video. The system can be a platform that sorts media into micro groups based on sets of comparable photos, where the groups can be defined by event, sequence, people, actions, context, or other criteria. The system can include back-end technology created for the intelligent recalling of specific images (algorithms and intelligent processing) and a front-end application that delivers this data to the consumer user (e.g., an application or application). The front-end application can include a search engine that enables the user to search the micro-groups to find relevant photos and video more quickly than is possible with currently-available camera applications.

Context-aware mobile search based on user activities, U.S. Patent Appl. Publ. No. 2012/0269116 (filed Apr. 25, 2011), provides improvement of search processes by modeling a mobile device user's context for a particular mobile search activity. Activity data characterizing usage of the mobile communications device is collected. This data may include the user's usage of the music and video player, including the types of media and specific titles, as well as activity data related to phone calls and other communications activities. The activity information is used by a predictive model to predict search parameters based on recent activity data. The predictive model can provide suggested search parameters, based on the user's recent activity as well as on search-specific user input. In some cases, the predictive model may be used to re-order the search results returned from a conventional search engine, based on the collected activity data.

Method and device for retrieving application, Chinese Patent No. CN103914552A (priority Apr. 14, 2014), provides a method and a device for retrieving application. The method for retrieving the application includes receiving a search word inputted by a user; searching an application matched with the search word in a preliminarily optimized search library; displaying the application matched with the search word to the user. The search library contains at least one application and optimized forward tables corresponding to the applications, and each optimized forward table comprises current characteristics and historical characteristics of the corresponding applications. The method and the device in an embodiment of the invention have the advantages that the current characteristics are acquired, the corresponding applications are normalized and processed according to the current characteristics, accordingly, large quantities of characteristics are added into the forward tables of the relevant applications, and the relevancy of the relevant applications can be optimized, reasonable search results can be acquired when the user searches the applications, and the user experience can be improved..

System and method providing search results based on user interaction with content, U.S. Patent Appl. Publ. No. 2013/0159298 (filed Dec. 20, 2011), provides search results based on user interaction with content. A server receives identification of a plurality of clicks of encoded uniform resource locator (URL) links and identifies, for each of the plurality of clicks, data about a user who clicked an encoded URL link and traffic data associated with the user's device. The server may store a record comprising data about the user and traffic data associated with each click. The server may determine, based on the records, a relevancy score for each content identified from decoding the encoded URL links. The server may also communicate, responsive to receiving a request to search content based on a keyword, a set of search results based on the keyword and the relevancy score.

Categorization of a mobile user profile based on browse behavior, U.S. Patent Appl. Publ. No. 2008/0214157 (priority Nov. 5, 2005), provides a method and system for using wireless provider data to ascertain a web browser activity, recording a user's mobile web browser activity performed on a mobile communication facility, storing a plurality of mobile web browser activities to determine a relationship among web browser activities, creating a category of user profile based at least in part on the analysis, associating the category of user profile with the user, and presenting a content to the mobile communication facility based at least in part on the category of user profile.

The prior art inventions either provide a free-standing application which is not completely suitable for sorting search results of other applications, or incorporate some feature or features into existing applications which may provide a marginally greater level of convenience. Embodiments of the invention described in this specification relate generally to sorting and categorizing processes, and more particularly, to a process for using location data obtained via the Global Positioning System (GPS), or some other electronic positioning system to sort and categorize mobile applications.

Currently, there are no convenient ways to sort through locationally relevant applications by categories. For example, on current mobile application stores there are no methods to sort through electronic positioning results of categories such as for “Dating” or “Transportation”—all applications are displayed in one list. This is a problem because underlying function of an application is important to users, more than simple proximity location—electronic positioning application results are essentially meaningless unless the user can differentiate by function. Under the current system, a mobile user would have to run many different searches to browse locationally-relevant applications by different concepts or functions.

The current alternative systems as a whole are inefficient in displaying relevant mobile applications pertaining to location. They are not grouped with respect to categories, or nearest large metropolitan area. As a result, location-specific searches are often too narrow or wide in scope, and users have to search multiple times to generate results of applications they are looking for near them.

The ability to filter categories among location-specific application results displayed in an interface creates much greater additional value, as the user can quickly and easily screen applications pertaining to “Dating,” “Transportation” or other categories near them, where both location and underlying functionality are equally important. Additionally, browsing is encouraged under this system, as users do not have to continually enter new terms and hit search to generate new application search results. A process for locationally sorting and categorizing mobile application results at a geographical level, utilizing GPS or some other electronic positioning system, would resolve the problems of prior art inventions.

### SUMMARY OF THE INVENTION

Accordingly, the invention is directed to a process for locationally sorting and categorizing mobile application results at a geographical level,

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of a mobile device displaying the homepage of the first exemplary embodiment, displaying the homepage 10, the interactive map 11, the application icons 11A, the category filters 12, the application displays 13, the mobile device 19, and the visual display 20.

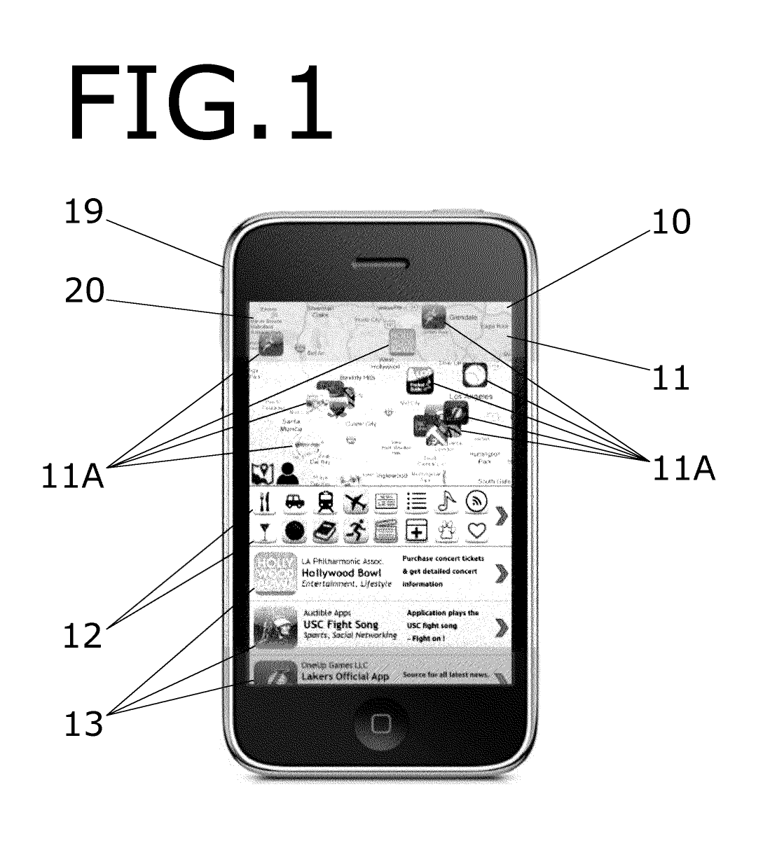

FIG. 2 is a front view of a mobile device displaying the metro areas page of the first exemplary embodiment, displaying the metro areas page 14, the location display 15, the metro areas display 16, the mobile device 19, and the visual display 20.

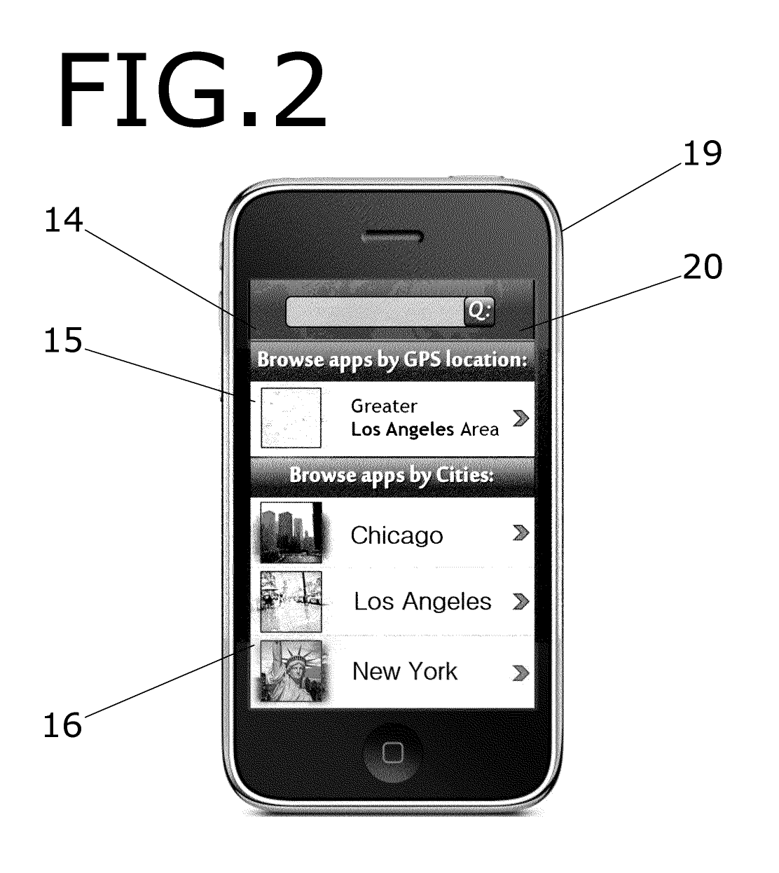

FIG. 3 is a front view of a mobile device displaying the category listing page of the first exemplary embodiment, displaying the category listing page 17, the category displays 18, the mobile device 19, and the visual display 20.

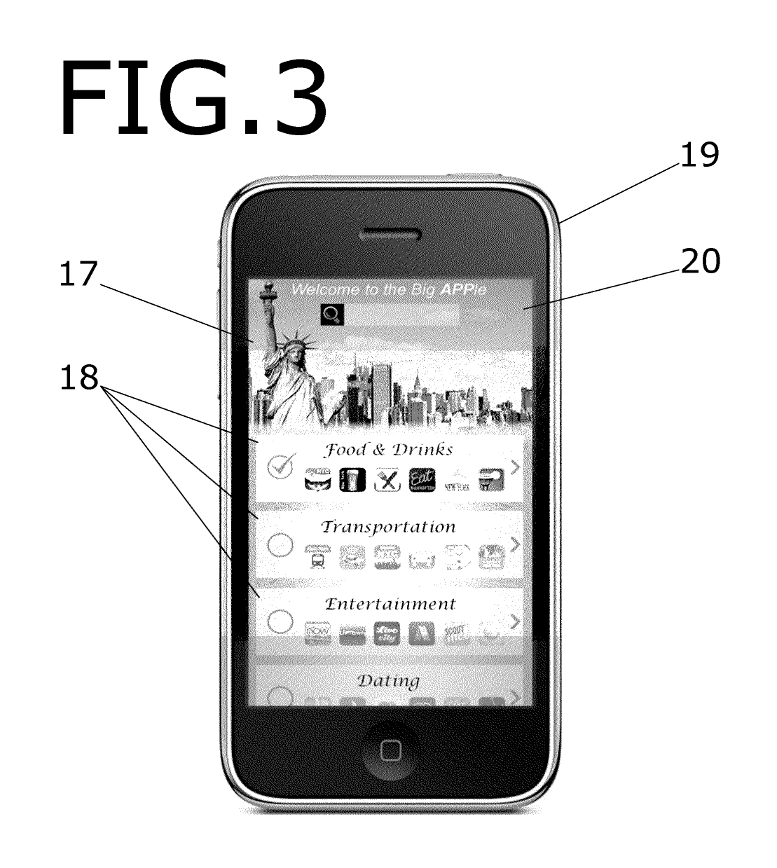

FIG. 4 shows a flowchart displaying the system components, features, communications, and their interconnections, and other relevant processes and events during the course of using the invention.

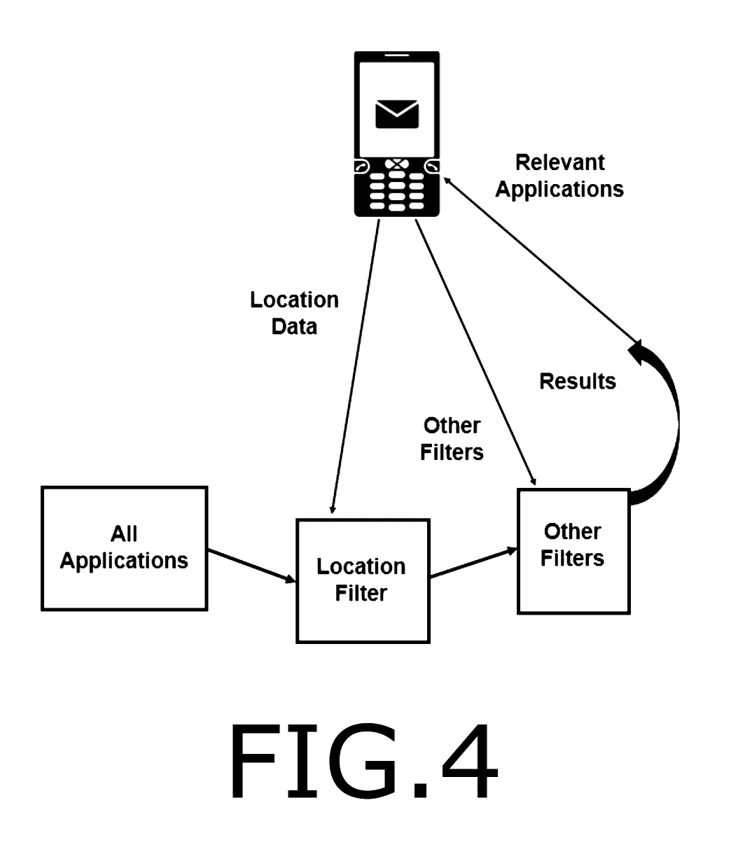

FIG. 5 is a front view of a mobile device displaying the second map view page of the first exemplary embodiment, displaying the interactive map 11, the application icons 11A, the category filters 12, the application displays 13, the mobile device 19, the visual display 20, the second map view page 21, the search window 22, and the friends button 23.

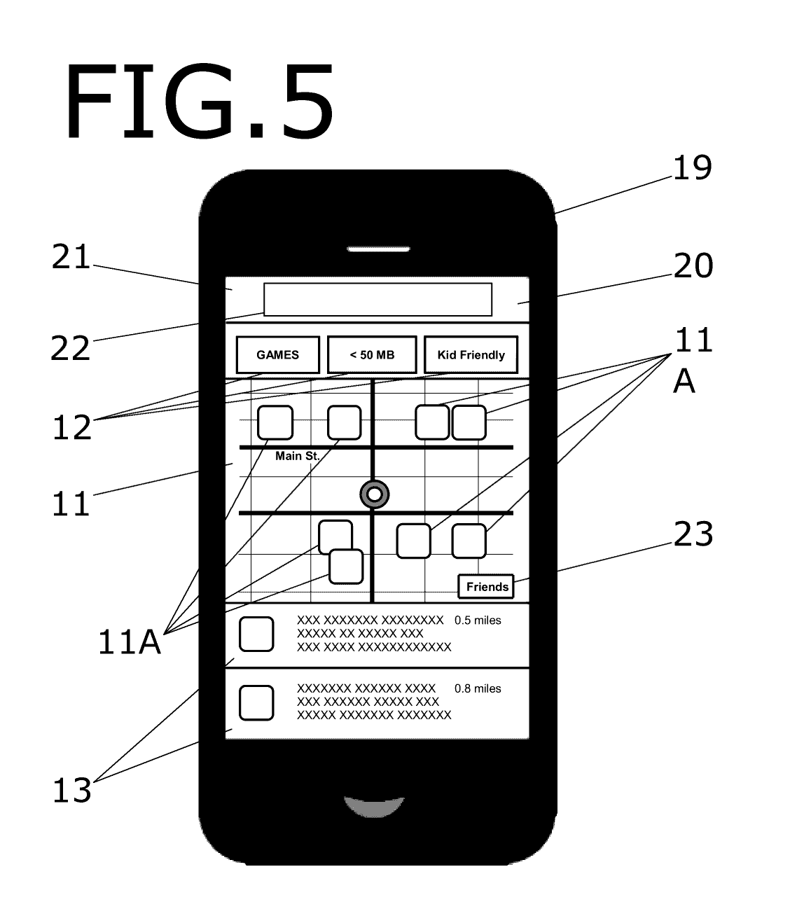

FIG. 6 is a front view of a mobile device displaying the filters page of the first exemplary embodiment, displaying the mobile device 19, the visual display 20, the search window 22, the filters page 24, and the filter displays 25.

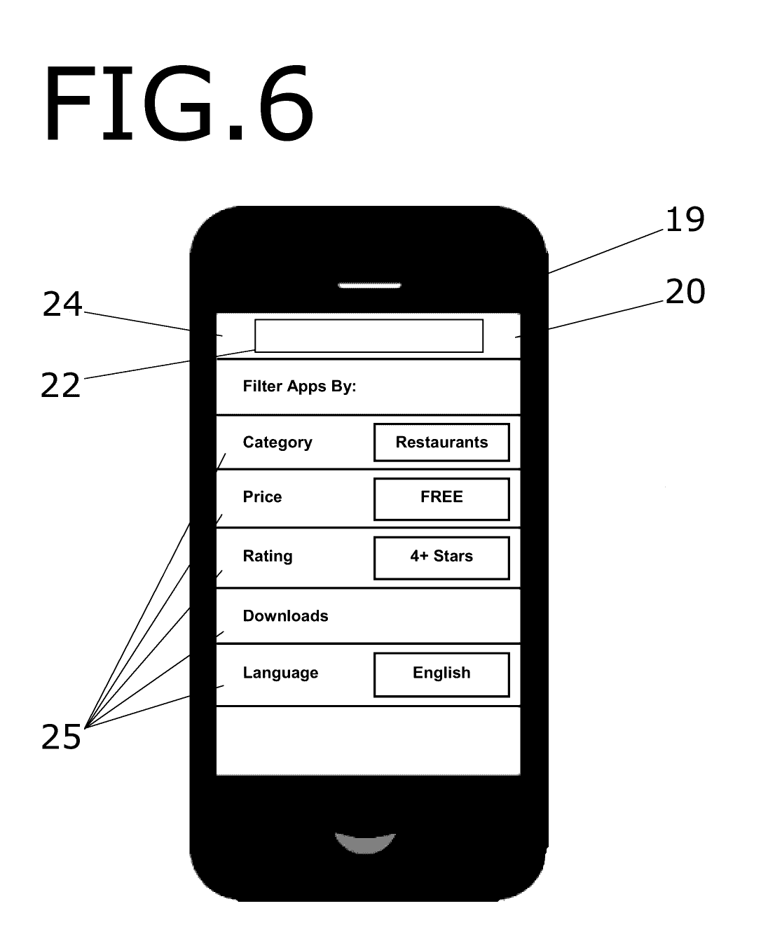

FIG. 7 shows a flowchart displaying the system components, features, communications, and their interconnections, and other relevant processes and events during the course of narrowing a search by progressively applying additional features.

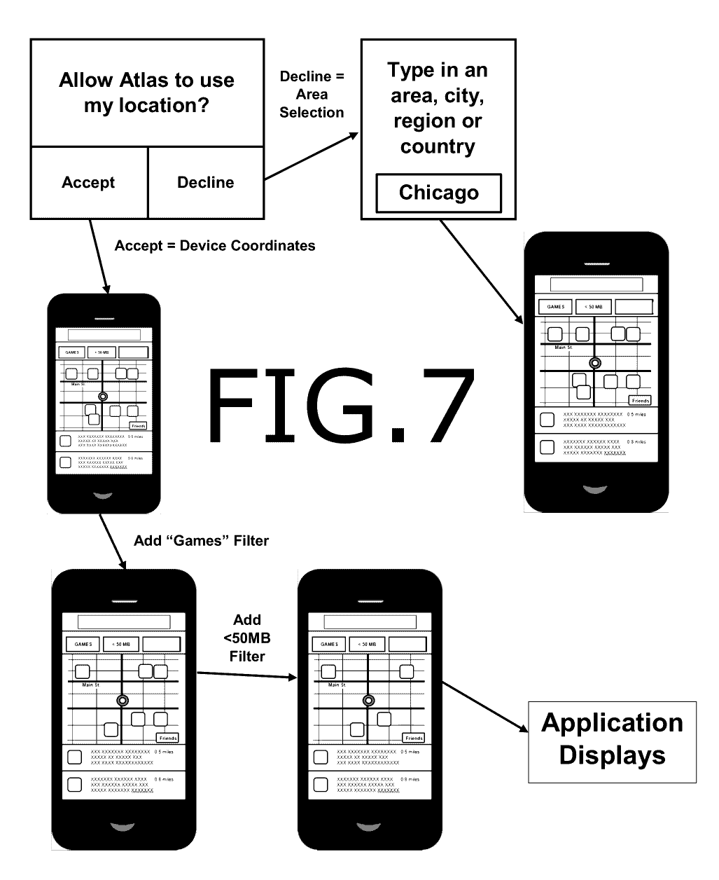

### DETAILED DESCRIPTION OF THE INVENTION

Referring now to the invention in more detail, the invention is directed to a process for locationally sorting and categorizing mobile application results at a geographical level.

As stated above, currently, there are no convenient ways to sort through locationally relevant applications by categories. For example, on current mobile application stores there is no means to sort through electronic positioning results of categories such as for “Dating” or “Transportation”—all applications are displayed in one list. This is a problem because underlying function of an application is important to users, more so than simple proximity locatio—electronic positioning application results are essentially meaningless unless the user can differentiate by function. Under the current system, a mobile user would have to run many different searches to browse locationally-relevant application results by different concepts or functions.

Embodiments of the invention described in this specification solve such problems by creating the ability for users to see electronic positioning results for applications by category, using a selection interface tied to an interactive map 11, with respect to the user's nearest city location. The user can instantaneously filter what they are looking for by category, and relevant applications are displayed in real-time in their corresponding physical locations. This eliminates the need to, and frustration with, running multiple searches to browse new application search results by concept or category.

The embodiments described in this specification differ from and improve upon currently existing options. In particular, some embodiments differ by the introduction of a user interface and ability to sort through locationally relevant applications by filters such as category, and see categorically selected applications appear on an interactive map 11, adds value to all electronic positioning based application searching. The value is created in user convenience and simplicity. The user does not have to search multiple times to generate new application results. Additionally, value is added to applications which would benefit from this system. For example, a mobile user in New York would use the present invention's location searching to find restaurant applications nearby—the interactive map 11 would display New York restaurant application icons where individual restaurants are physically located. This adds value, and increases traffic, for organizations which have their own mobile applications. It also adds value for organizations which use already existing mobile applications for their services (ex: value in showing locations of restaurants near you which support a food delivery app).

In addition, these embodiments improve upon the currently existing options because sorting by function is a key purpose of a mobile application searching platform. By not offering additional filtering of location results, a large inefficiency is created as users cannot always find what the applications are looking for, or a user must individually run different searches to generate new results, and no map element is provided for location reference, often leading to user confusion and wasted time. The ability to filter categories among electronic positioning displayed application results in an interface creates much greater additional value, as the user can quickly and easily screen applications pertaining to “Dating,” “Transportation,” or other categories near the user, where both location and underlying functionality are equally important. Additionally, browsing is encouraged under this system, as users do not have to continually enter new terms and hit “search” to generate new application search results.

Some embodiments include a novel process for locationally sorting and categorizing mobile applications at a geographical level by utilizing location data which can be obtained from a mobile application's information. This may be comprised of the following elements. This list of possible constituent elements is intended to be exemplary only and it is not intended that this list be used to limit the process of the present application to just these elements. Persons having ordinary skill in the art relevant to the present disclosure may understand there to be equivalent elements that may be substituted within the present disclosure without changing the essential function or operation of the process for locationally sorting and filtering mobile applications by location search metrics.

1. Interactive Map 11

2. Application Icon(s) 11A

3. Category Filters 12

4. Displayed Results

The various elements of the process of the present disclosure may be related in the following exemplary fashion. It is not intended to limit the scope or nature of the relationships between the various elements and the following examples are presented as illustrative examples only. #1 (Interactive Map 11) relates to #2 (Application Icons 11A) in that #2 is displayed on #1. #3 (Category Filters 12) relates to #2 and #4 (Displayed Results) in that selection or deselection of individual #3 category filters results in either the addition or subtraction of #2 application icons 11A on the interactive map 11 and in displayed application results #4.

The first exemplary embodiment is preferably comprised of five pages, which may be made available on the visual display 20 of a mobile device 19: a homepage 10, displaying the interactive map 11, the application icons 11A, the category filters 12, and the application displays 13; a metro areas page 14, displaying the location display 15, and the metro areas display 16; a category listing page 17, displaying the category displays 18; the second map page view 21, displaying the interactive map 11, the application icons 11A, the category filters 12, the application displays 13, the search window 22, and the friends button 23; and a filters page 24, displaying the search window 22 and the filter displays 25. More or fewer pages are contemplated. Optionally, the search window 22 may be displayed on additional pages.

The process of the present disclosure generally works by way of the software which pulls from multiple criteria to determine what is relevant to the city location. This is comprised of number of downloads of an application within a particular area radius, application name and application description, and social media information, as well as other factors. From this master list of results the software has created, the software further allows the user to sort through the master list of relevant application results, by category. This is accomplished by the user selecting a category filter button, which tells the software to limit displayed application relevant results to that particular category, multiple categories, key search terms, or all of the above that the user has employed to select or limit the search.

On the metro areas page 14, the user is prompted to submit the user's current location via the location display 15. Upon submission of user location, the platform utilizes GPS, or some other electronic positioning system, to set location to nearest city to user on the interactive map 11. Alternately, the user may select a metro area from the metro areas display 16. It is to be understood that a metro area may be comprised of a neighborhood, a city with its suburbs, a small town, a county, a state or province, a small country such as Luxembourg or Monaco, or any other compact and contiguous inhabited area. On the interactive map 11 are displayed application icons 11A which are relevant to the greater city area. The user selects category filters 12 below the interactive map 11 to sort through categories of applications which are of interest, or restricts search terms to categories of interest. If user selects or deselects a category, then application icons 11A on the interactive map 11 and results displayed below the interactive map 11, corresponding to said category, are displayed, or are not displayed, respectively. User can select from displayed results to download the applications which are of interest.

To make the process of the present disclosure, one may create software that is capable of determining where a user is located, and determining what mobile applications are and are not locationally relevant to said user area. The software must also be able, from a master list of mobile applications relevant to said area, to further distinguish applications by filters, and offer the interface and the tools necessary for a mobile user to sort through these locationally relevant applications by filter, and then display these results to the user both on an interactive map 11 pertaining to the resulted applications' physical locations, and as a list of results.

The interactive map 11 which displays application icons 11A respective to their corresponding physical locations is optional. This is because the underlying value is in list generation of locationally relevant applications by category. Alternate embodiments may add download locations by the user's friends by category displayed on a map, which may be accessed by clicking on the friends button 23 on the second map view page 21, but this would require individual user approval after connection through social media.

List of displayed application results, and application results displayed on the interactive map 11, are interchangeable in the sense that at least one, but not both, are required for user selection of category filters 12 respective to location-specific application results to be relevant and useful. It is to be understood that the locations of applications discovered by a search may be flexible, such as with Uber and Lyft drivers whose locations are constantly being updated. Thus the present invention may reveal that at the moment of the search, an Uber driver is five minutes away but a Lyft driver is 20 minutes away, enabling the user to make a more fully informed selection. The process provides fully updated information associated with locations material to the functionality of the applications in the geographic area being displayed, and thus may result in application icons 11A which move.

To use the first exemplary embodiment, a user would interact with the software and agree to allow use of the user's current location (obtained wherever the user is located). Using this information, the process may be used to obtain location-relevant applications. Thus, new user location may automatically be set to the nearest city area, and the user would then automatically be shown an interactive map 11 of the nearest city location, with application icons 11A displayed on the interactive map 11, and results displayed in a list below category filters 12. The user can then select or deselect any category filters 12 directly below the interactive map 11. Applications displayed on the interactive map 11 and listed in search results would be reflected of what the user selected for category filters 12. The user may elect to progressively narrow the search by applying additional filters. The user can then select any application by clicking on the corresponding application icon 11A from the interactive map 11 or the newly displayed list, and download an application directly.

In alternate embodiments, the process for locationally sorting and categorizing mobile applications at a geographical level by utilizing location data obtained from GPS or some other electronic positioning system can be adapted for broader applications in fields where users self-select into searchable categories, where location metrics are relevant to, and help in determining, search results where filtering and map display is necessary for efficiency of the platform.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A process for locationally sorting and filtering mobile applications at a geographical level by utilizing location data obtained from an electronic positioning system comprising:
a. an interactive map displaying a geographic area containing physical locations;
b. a set of mobile applications having application icons;
c. each of said mobile applications being associated with one or more physical locations in one or more geographical areas;
d. a set of results including mobile applications associated with physical locations within the geographical area displayed by the interactive map;
e. said interactive map displaying the application icons associated with the mobile applications included in the set of results;
f. a list displaying the mobile applications included in the set of results;
g. one or more filters providing a set of requirements for sorting and categorizing the set of mobile applications based on the function of the mobile application;
h. a display screen;
i. said display screen displaying the interactive map and the list;
wherein a geographical area is selected; a set of results is determined by including mobile applications associated with physical locations in the geographical area;
application icons associated with the mobile applications in the set of results are displayed on an interactive map; the application icons are displayed at the physical locations associated with those mobile applications; the mobile applications included in the set of results are displayed on a list; the interactive map and the list are displayed on the display screen; and the set of results may be filtered using a set of filters to sort and categorize the mobile applications based on function.

2. The process of claim 1, comprising at least three pages, which are displayed on the display screen; said at least three pages including at least three of:
a. a homepage; the homepage displaying the interactive map, the application icons, one or more filters, and the list of mobile applications included in the set of results;
b. a metro areas page; displaying a current location display, and a metro areas display providing a list of metro areas; and
c. a category listing page; displaying category displays;
d. a map page; displaying the interactive map, the application icons, the category filters, the list of mobile applications included in the set of results, a search window, and a friends button; and
e. a filters page; displaying a search window and a filter display. wherein the user can switch between the three pages.

3. The process of claim 1, wherein a web-connected device is capable of providing a current location of the web-connected device using an electronic positioning system.

4. The process of claim 3, wherein the geographic area is defined by automatically determining the area proximate to the current location of the web-connected device.

5. The process of claim 4, wherein any of the filters are selected or deselected, such that the set of results only include those mobile applications which satisfy the set of requirements for sorting and categorizing the set of mobile applications based on the function of the mobile application.

6. The process of claim 5, wherein only the set of results which satisfy the filter requirements are displayed on the interactive map and the list.

7. The process of claim 1, wherein the mobile applications are selected by clicking on the corresponding application icon on the interactive map or the list; selected applications are then purchased for download.

8. The process of claim 4, wherein the mobile applications are selected by clicking on the corresponding application icon on the interactive map or the list; selected applications are then purchased for download.

9. The process of claim 6, wherein the mobile applications are selected by clicking on the corresponding application icon on the interactive map or the list; selected applications are then purchased for download.

10. The process of claim 2, wherein a location is selected from the list of metro areas on the metro areas page.

11. The process of claim 10, wherein the geographic area is defined by an area proximate to the location selected.

12. The process of claim 11, wherein any of the filters are selected or deselected, such that the set of results only include those mobile applications which satisfy the set of requirements for sorting and categorizing the set of mobile applications based on the function of the mobile application.

13. The process of claim 12, wherein only the set of results which satisfy the filter requirements are displayed on the interactive map and the list.

14. The process of claim 11, wherein the mobile applications are selected by clicking on the corresponding application icon on the interactive map or the list; selected applications are then purchased for download.

15. The process of claim 13, wherein the mobile applications are selected by clicking on the corresponding application icon on the interactive map or the list; selected applications are then purchased for download.

16. The process of claim 2, wherein a web-connected device is capable of providing a current location of the web-connected device using an electronic positioning system; and the geographic area is defined by automatically determining the area proximate to the current location of the web-connected device.

17. The process of claim 16, wherein any of the filters are selected or deselected, such that the set of results only include those mobile applications which satisfy the set of requirements for sorting and categorizing the set of mobile applications based on the function of the mobile application.

18. The process of claim 17, wherein only the set of results which satisfy the filter requirements are displayed on the interactive map and the list.

19. The process of claim 16, wherein the mobile applications are selected by clicking on the corresponding application icon on the interactive map or the list; selected applications are then purchased for download.

20. The process of claim 18, wherein the mobile applications are selected by clicking on the corresponding application icon on the interactive map or the list; selected applications are then purchased for download.
